(19) United States
(12) Patent Application Publication
(10) Pub. No.: US 2025/0277970 A1
(43) Pub. Date: Sep. 4, 2025

(54) METHOD, SYSTEM AND LOCALIZATION MICROSCOPE FOR ABERRATION CORRECTION AND FOR LOCALIZING OR TRACKING EMITTERS

(71) Applicant: ABBERIOR INSTRUMENTS GMBH, Gottingen (DE)

(72) Inventor: Jorn HEINE, Witzenhausen (DE)

(21) Appl. No.: 19/067,178

(22) Filed: Feb. 28, 2025

(30) Foreign Application Priority Data
Mar. 1, 2024 (DE) 10 2024 106 001.8

(51) Int. Cl. G02B 27/00; G02B 21/00

(52) U.S. Cl. CPC G02B 27/0068; G02B 21/0032

(57) ABSTRACT

The present disclosure relates to a method for aberration correction of an illumination light, wherein in a sample a focus of the illumination light comprising an intensity distribution, which comprises a local minimum, is generated, wherein the sample is scanned with the intensity distribution at scanning positions forming a pattern around an estimated position of a singulated emitter, and wherein light emissions of the emitter are detected for each of the scanning positions, wherein a value of a parameter or a support point of an aberration correction function is determined based on the detected emissions, wherein the aberration correction function describes a deviation of a shape of the intensity distribution from a desired shape or a deviation of a phase distribution of the illumination light from a desired phase distribution, as well as a system, a localization microscope, and a method for localizing or tracking emitters using the method.

### CROSS-REFERENCE TO RELATED APPLICATIONS

The present application claims the benefit of and priority to DE Patent Application Serial No. DE 10 2024 106 001.8, filed Mar. 1, 2024, the entire contents of which is incorporated herein by reference.

### TECHNICAL FIELD

The present disclosure relates to a method for aberration correction of an illumination light for a localization microscope, in particular a MINFLUX microscope, as well as a system and a non-transitory computer-readable medium for carrying out the method for aberration correction. Further objects of the disclosure are a method for localizing or tracking a singulated emitter in a sample, in particular a MINFLUX method, using the method for aberration correction, as well as a localization microscope, in particular a MINFLUX microscope, and a non-transitory computer-readable medium for carrying out the method for localizing or tracking a singulated emitter.

### PRIOR ART

In optics, aberrations are defined as deviations from an ideal optical image produced by an optical system.

Chromatic aberrations caused by the wavelength dependence of refraction are largely corrected in higher-quality microscope objectives by special lens systems.

Other aberrations, such as spherical aberrations, astigmatism and coma, manifest themselves in microscopy primarily as a result of refractive index differences between the specimen, cover glass and immersion medium between the objective lens and cover glass. Spherical aberrations have particularly strong effects in microscopic examination of areas that are located deep in the sample, i.e. at a relatively large distance from the cover glass.

Depending on the microscopy technique, aberrations can deform the excitation and/or detection point spread function (PSF), which can lead, in particular, to lower resolution and reduced image contrast. These effects are particularly strong when using objectives with a high numerical aperture.

Devices that can change the wavefront of a light beam in such a way that aberrations are corrected or compensated for are known from the prior art. Such devices can be, for example, deformable mirrors or spatial light modulators (SLM) with controllable pixels for phase modulation of the wavefront.

In sensor-based aberration correction, the wavefront of the aberrated light beam can be detected with a sensor, e.g. a so-called Shack-Hartmann sensor, in order to then control a wavefront modulator based on the detected wavefront, which corrects the aberration. Such a method is described, for example, in the publication “3D super-resolution deep-tissue imaging in living mice” by M.G.M. Velasco et al., optica 8 (4), 442-450 (2021).

Sensorless methods are known as an alternative to sensor-based aberration correction, which may be based on an image metric, for example. Therein, the control parameters of the wavefront modulator are changed until the image quality parameters approach the desired values.

For example, US 2015/0226950 A1 describes a STED microscopy method and a corresponding microscope with which a phase pattern displayed on a phase modulator (spatial light modulator) is adjusted using an image quality metric in order to correct aberrations of the STED light beam and also optionally of the excitation light beam. The metric is based on an image sharpness parameter and an image brightness parameter.

A further sensorless aberration correction method, in which sectional images are evaluated in planes parallel to the optical axis of the objective, is described in patent application US 2022/0244515 A1. Among other things, it is proposed there to use the described method for aberration correction for a MINFLUX method, wherein the determination of the aberration correction values is based on an image acquisition with confocal laser scanning microscopy using the MINFLUX excitation wavelength.

The article “Aberrations and adaptive optics in super-resolution microscopy” by M. Booth et al, Microscopy (2015) 251-261, gives an overview of the effect of aberrations on various super-resolution microscopy techniques where resolutions below the classical light microscopic diffraction limit can be achieved, such as STED (stimulated emission depletion), SMS (single modecule switching) and SI (structured illumination) microscopy.

Compared to conventional light microscopy, localization microscopy uses a fundamentally different image generation mechanism. With such techniques, e.g. PALM/STORM and MINFLUX, there is no classic imaging or scanning of the image field, but rather the positions of singulated emitters, e.g. singulated fluorophores, are determined and an image is then obtained from the individual localizations.

Therefore, aberration correction methods based on image evaluation are not applicable to localization microscopy. This applies in particular to the MINFLUX technique.

The term “MINFLUX microscopy” is used in the prior art to describe a family of localization and tracking methods for singulated light-emitting emitters in which an intensity distribution of illumination light, which induces or modulates light emissions from the emitter, is generated at the focus in the sample, the intensity distribution having a local minimum in at least one spatial direction, and in which the position of a single emitter is determined by detecting light emissions from the emitter.

The term “MINFLUX” is used for the first time in the publication “F. Balzarotti et al, “Nanometer resolution imaging and tracking of fluorescent molecules with minimal photon fluxes”, Science 355 (6325), 606-612 (2017)”. There, the MINFLUX principle described above is implemented in concrete terms by first pre-localizing a single fluorophore by scanning it with a first Gaussian-shaped excitation light distribution and then placing a second, donut-shaped excitation light distribution at points that form a symmetrical pattern of four illumination positions around the position of the fluorophore estimated in the pre-localization. The position of the fluorophore is then determined to within a few nanometers from the photon counts registered for the individual illumination positions using a maximum likelihood estimator.

Further variants and embodiments of MINFLUX microscopy are described in patent applications US 2019/0234879 A1, US 2019/0234882 A1 and US 2019/0235220 A1.

The publication “K. C. Gwosch et al, “MINFLUX nanoscopy delivers 3D multicolor nanometer resolution in cells”, Nat. Methods, 17 (2), 217-224 (2020)” describes iterative 2D and 3D MINFLUX microscopy methods. The sample is illuminated in several iteration steps at illumination positions with the minimum of a donut-shaped excitation light distribution, wherein the illumination positions form a symmetrical illumination pattern centered around the position of the fluorophore estimated in the previous step, and wherein the illumination positions are placed closer around the currently estimated position of the fluorophore in each iteration step. This makes it possible to achieve very high positioning accuracy in just a few steps.

Another iterative MINFLUX localization and tracking method using a modified position estimator and based on a commercial microscope setup is described in “R. Schmidt et al, “MINFLUX nanometer-scale 3D imaging and microsecond-range tracking on a common fluorescence microscope”, Nat. Commun. 12 (1), 1478 (2021)”.

The light that induces or modulates the light emission of the particles may also be STED (stimulated emission depletion) light, for example. The patent applications US 2018/0259458 A1 and US 2020/0393378 A1 disclose MINFLUX-like methods that are based on superimposing an excitation light distribution with a local maximum on a STED light distribution with a local minimum. The sample is scanned by shifting the STED distribution with the STED minimum and the position of the fluorophore is determined from the measured values of the fluorescence intensity at different positions of the STED intensity distribution.

Patent application US 2024/0245190 A1 describes a localization microscopy method, in particular a MINFLUX method, in which a systematic deviation in the localization of emitters between early iteration steps and later iteration steps is corrected by means of a position correction.

This method is in principle capable of correcting localization offsets caused by imaging errors, but requires a relatively high computational effort and therefore has disadvantages for live measurements.

However, it would be desirable to be able to correct the effects of aberrations on localization microscopy methods such as MINFLUX microscopy in an improved way, especially with regard to flexible correction of a wide range of aberrations depending on the sample and environmental conditions as well as rapid correction during live measurements.

### Objective

In view of the disadvantages of the prior art discussed above, it is the objective of the present disclosure to provide a method for aberration correction of an illumination light for a localization microscope and a corresponding method for localizing or tracking emitters in a sample, which makes it possible to localize singulated emitters in a simple and flexible manner, in particular also deep in a sample, quickly and with high accuracy, wherein in particular also the quality of live measurements can be improved.

### Solution

This objective is attained by the subject matter of the independent claims. Advantageous further embodiments are indicated in the subclaims and described below.

### DESCRIPTION

A first aspect of the disclosure relates to a method for aberration correction of an illumination light for a localization microscope, in particular a MINFLUX microscope, wherein the illumination light is focused into a sample, wherein an intensity distribution of the illumination light with at least one local minimum is generated at the focus of the illumination light in the sample, and wherein the sample is scanned in at least one scanning step with the intensity distribution at scanning positions which form a scanning pattern around a first estimated position of a singulated emitter in the sample, wherein light emissions of the singulated emitter induced or modulated by the illumination light are respectively detected for the scanning positions, and wherein a value of at least one parameter (in particular values of several parameters) or at least one support point (in particular several support points) of an aberration correction function is determined based on the light emissions detected for the different scanning positions, wherein the aberration correction function describes a deviation of a shape of the intensity distribution of the illumination light from a desired shape of the intensity distribution or a deviation of a phase distribution of the illumination light from a desired phase distribution.

The data acquisition for aberration correction is thus carried out according to the present disclosure in a similar way to a MINFLUX method for localizing or tracking singulated emitters—in contrast to the prior art, however, the recorded light emissions are used to determine parameter values or support points of an aberration correction function. This makes it possible to use a localization microscope to perform aberration correction in a simple and precise manner without additional hardware components, which in particular enables singulated emitters to be localized or tracked quickly and with very high accuracy, even deep in a relatively thick sample.

With the method according to the present disclosure, useful parameters for aberration correction can be determined in a single measurement cycle, in contrast to aberration correction methods that perform and optimize image recordings in an iterative loop in order to maximize an image quality metric.

Since an intensity distribution is used that can also be used for localization (in particular according to a MINFLUX method), the detected light emissions can optionally also be used twice-on the one hand for aberration correction and on the other hand for localization of the corresponding emitters, e.g. by subsequent data processing. In other words, part of the localization data that is already available can advantageously be used additionally for aberration correction.

The aberration correction function can be a continuous or a discrete function. It describes a deviation of a shape of the intensity distribution or a phase distribution of the illumination light from a desired shape. The aberration correction function may thereby describe the shape of the intensity distribution at the focus in the sample, such as a point spread function, wherein the parameter determined according to the present disclosure may be, for example, a shape parameter which can describe, for example, a skewness of the intensity distribution or an intensity value at the minimum of the intensity distribution.

The desired shape of the intensity distribution at the focus in the sample may in particular be point-symmetrical with respect to the local minimum and/or the local minimum of the desired shape of the intensity distribution may be a zero point. Such a desired shape may in particular correspond to a shape of the intensity distribution that would result from ideal illumination without aberrations.

As an alternative to describing an intensity distribution in the sample, the aberration correction function may, for example, describe a phase distribution of the illumination light in a rear aperture of an objective focusing the illumination light into the sample or in a plane conjugate to the rear aperture (pupil plane). In particular, the aberration correction function may comprise an orthogonal system of correction terms, e.g. Zernike polynomials.

The aberration correction function may also be defined, for example, by a matrix of parameter values or support points. These values may, for example, correspond to the values with which mechanical actuators of a deformable mirror or pixels of a controllable spatial light modulator must be controlled so that they compensate for the deviation of the shape of the intensity distribution from the desired shape, so that the desired shape results in the sample.

In the context of the present specification, the term “localization microscope” refers to a light microscope configured to determine the positions of singulated emitters in a sample.

In the context of the present specification, a “MINFLUX microscope” is a localization microscope that is configured to determine the positions of singulated emitters in a sample according to a MINFLUX method.

A “MINFLUX method” in the context of the present specification is a method for localizing or tracking a singulated emitter in a sample, wherein an illumination light is focused into a sample, in particular in a region around a first estimated position of a singulated emitter, wherein an intensity distribution of the illumination light with a local minimum is generated at the focus of the illumination light in the sample, and wherein for different scanning positions of the intensity distribution or different shapes and/or arrangements of the intensity distribution, respective light emissions of the singulated emitter induced or modulated by the illumination light are detected, and wherein based on the light emissions and the associated scanning positions or shapes and/or arrangements, a further estimated position of the singulated emitter is determined with higher accuracy than the first estimated position by means of a position estimator.

The term “emitter” refers to an object in the sample that acts as a point light source when illuminated with the illumination light. The light emissions may be caused directly by the emitter itself (especially if the emitter is a fluorescent dye molecule) or indirectly by a marker coupled to the emitter (e.g. fluorescent dye molecules covalently or non-covalently bound to a protein) or several such markers. For example, an emitter may also be an object to which several fluorophores are bound at a distance below the diffraction limit. Light emission may not only mean the active emission of light by the emitter or the markers in the sense of luminescence (in particular fluorescence), but also, for example, light emission caused by (Raman or Rayleigh) scattering. Specifically, the emitter or the markers coupled to the emitter may in particular be molecules of a fluorescent dye, fluorescent nanoparticles (e.g. quantum dots) or light-scattering nanoparticles such as gold nanoparticles or gold nanorods.

In the context of the present specification, “singulated” emitters are emitters that can be separated by optical means. In particular, this may mean that the emitters have a spatial distance to each other that is above the optical diffraction limit. However, emitters are also singulated in this sense if they can be registered one after the other, for example by registering light emanating from a first emitter at a time when a neighboring second emitter is not emitting light because it is in a dark state (in the case of fluorophores). In this way, emitters that have a distance below the diffraction limit but blink asynchronously can also separated by light microscopy. Finally, it is also possible to separate emitters that have a distance below the diffraction limit but emit light of different wavelengths by spectral separation of the emitted light under a light microscope or to excite two emitters with different excitation spectra with different wavelengths in order to optically separate the emitters. Finally, emitters with different emission lifetimes can be distinguished from each other by measuring the lifetime (e.g. by time-resolved single photon counting) and thus detected separately. All of these embodiments fall under the term “singulated emitters”.

In particular, the sample can be illuminated with an illumination light beam (e.g., a laser beam) of the illumination light, wherein the illumination light may be focused into the sample by an objective of the localization microscope.

The illumination light may, for example, be excitation light that excites emitters in the sample to luminescence, in particular fluorescence, or is reflected or scattered by emitters in the sample, i.e. induces the light emissions. Alternatively, the illumination light may also be, for example, inhibition light (e.g. STED light), which returns the emitters from an excited state (in particular by an excitation light different from the illumination light) to a ground state. Therein, the inhibition light is light that modulates the light emissions of the emitters.

In particular, the illumination light may be the same illumination light that is also used in the method for localizing or tracking singulated emitters according to the fourth aspect. This facilitates the correction of the aberrations occurring in the method for localizing or tracking singulated emitters by means of the determined parameters or support points of the aberration correction function. In particular, the illumination light may have the same wavelength or the same spectrum in both methods, wherein the intensities of the illumination light in the method for aberration correction and the method for localizing or tracking singulated emitters may differ. However, it may also be advantageous to use different illumination lights for the methods according to the first aspect and the fourth aspect.

An intensity distribution of the illumination light with a local minimum is generated at the focus of the illumination light in the sample. This local minimum may in particular be a central local minimum, wherein the local minimum may, for example, be located at the geometric focus. Ideally, the minimum is an intensity zero. However, the intensity of the illumination light at the minimum may be greater than zero, e.g. due to the influence of aberrations. The local minimum may be bordered on both sides by intensity increase areas, particularly in at least one spatial direction. Specifically, the intensity distribution may be a donut, for example, in which intensity increase areas are adjacent to a central zero in all directions in the focal plane perpendicular to the optical axis of the objective. A donut is particularly suitable for 2D localization in the focal plane. The intensity distribution may also be a so-called bottle beam or 3D donut, in which intensity increase areas are adjacent to the central zero both in the focal plane (lateral) and along the optical axis (axial), i.e. in all three spatial directions. Further examples are light distributions with two intensity maxima that are separated by a surface of zero intensity, wherein the surface intersects the geometric focus.

The intensity distribution can be generated, for example, by phase modulation of the illumination light beam with a phase plate or a spatial light modulator and subsequent focusing through the objective of the localization microscope.

The same intensity distribution may be used for the method for aberration correction and the method for localizing or tracking singulated emitters. This has the advantage that the effects of aberrations can be taken into account particularly well during aberration correction. Alternatively, a different intensity distribution may be used for aberration correction than for localization or tracking of singulated emitters. For example, an optimized intensity distribution may be used for aberration correction, with which aberration correction parameters can be estimated particularly accurately. The determined aberration correction function may then be applied to the intensity distribution used in the method for localizing or tracking singulated emitters, e.g. a donut or a bottle beam.

The sample is scanned in at least one scanning step with the intensity distribution at scanning positions that form a scanning pattern around a first estimated position of a singulated emitter in the sample. Therein, the illumination light may be moved (e.g. with a beam scanner), the sample may be moved (e.g. by a so-called stage scanner) or both. The first estimated position may be determined analogously to a MINFLUX method by an independent method of lower accuracy, e.g. by scanning with a Gaussian focus, wide-field microscopy or pinhole orbit scanning. In the scanning step, the local minimum of the intensity distribution is arranged successively at the scanning positions. This can be done step by step, e.g. by moving the intensity distribution to the scanning positions one after the other and detecting light emissions during a waiting time in each case. Alternatively, the intensity distribution can also be moved continuously, e.g. on a circular path or another closed path around the first estimated position. In this variant, the scanning positions do not have to be fixed, but can be determined from the times at which the light emissions (in particular individual photons) are detected and the measured or calculated positions of the minimum of the intensity distribution assigned to the times.

As explained further below, the localization or tracking method according to the fourth aspect (e.g. MINFLUX method), for which the aberration correction according to the present disclosure is carried out, may also comprise steps in which the intensity distribution with the local minimum is positioned at different scanning positions in the sample. However, this is not absolutely necessary. The localization or tracking method may also be performed with an intensity distribution of the illumination light that is stationary in the sample by changing a shape and/or an orientation of the intensity distribution. For example, an intensity distribution with two maxima separated by an area of minimum intensity may be rotated around the geometric focus and the light emissions may be detected for the different orientations.

The detected light emissions may in particular be single photons or groups of photons. Single photons can be detected, for example, with avalanche photodiodes (APDs) or two-dimensional arrays of APDs, groups of photons, for example, by so-called hybrid photodetectors or arrays of hybrid photodetectors.

According to an embodiment, the value of the at least one parameter or the at least one support point of the aberration correction function is determined by a function fit of the light emissions detected for the different scanning positions to the desired intensity distribution of the illumination light at the focus in the sample.

For example, intensity values of a stored intensity distribution at positions corresponding to the scanning positions can be compared with the detected light emissions and parameter values (in particular aberration terms representing different aberrations) can be adjusted until the deviation is minimized. In particular, several stored intensity distributions with different aberrations can be compared with the measured values and the intensity distribution with the closest match can be selected. The parameter values of an aberration correction function stored for this intensity distribution, e.g. in a lookup table, can then be used for the aberration correction.

According to a further embodiment, the at least one parameter value or the at least one support point is determined by means of a trained data processing network, e.g. an artificial neural network, in particular wherein the data processing network may receive as input values the light emissions detected for the different scanning positions and may output the value of the at least one parameter or the at least one support point of the aberration correction function. Such a network may, for example, be trained with simulated light emission data. Alternatively or additionally, the data processing network may be trained or further trained based on measurement data, i.e. light emissions detected for different scanning positions as part of a method for aberration correction according to the present disclosure, e.g. using reinforcement learning. Various parameters are conceivable as an evaluation measure for training the data processing network, e.g. a residual deviation between the desired intensity distribution and the actual intensity distribution of the illumination light after aberration correction has taken place.

According to an embodiment, a beam shaping device (or beam shaper) is controlled in such a way that a shape of the intensity distribution of the illumination light is adapted based on the aberration correction function. Here, the at least one parameter value or the at least one support point of the aberration correction function is to be adapted in such a way that the adapted illumination light combined with the aberrations of the optical system from the beam path of the localization microscope and possibly the sample leads to an intensity distribution in the sample as a whole that approximates a desired intensity distribution. Such a desired intensity distribution is in particular point-symmetrical to the geometric focus within the focal plane. Furthermore, the, particularly central, local minimum of the desired intensity distribution may be a zero point.

Aberration correction by controlling a beam shaping device has the advantage that localization data is recorded directly under almost optimal conditions. This makes it possible to estimate the position from the localization data in the case of strong aberrations. In addition, the effort required for subsequent data processing can be reduced. Furthermore, this type of aberration correction is extremely advantageous for live position determination of emitters as well as for tracking experiments (tracking an emitter) and iterative localization methods, in which the accuracy of the estimated position of the emitter in each step is decisive for the subsequent steps and there is usually not enough time for live processing of the data. In particular, the aberration correction is carried out from previously recorded data, but it may also be carried out promptly and under the specific recording conditions of the sample to be examined.

According to a further embodiment, the beam shaping device comprises a deformable mirror and/or a spatial light modulator. A spatial light modulator can modulate the amplitude and/or the phase of the illumination light. When the illumination light beam is reflected by the appropriately adjusted deformable mirror, deviations from a flat wavefront caused by aberrations can be corrected in a manner known from the prior art. A spatial light modulator can be used to modulate the spatial phase distribution of the illumination light. This method can also be used to correct aberrations in a manner known from the prior art, e.g. by imposing phase distributions corresponding to the Zernike polynomials.

According to a further embodiment, a position estimator for estimating a position of a singulated emitter in a sample, in particular according to a MINFLUX method, is adapted based on the aberration correction function, in particular wherein an expression of the position estimator describing a shape of the intensity distribution is adapted based on the aberration correction function.

The position estimator is an estimation algorithm for the position of the singulated emitter, which in particular uses light emissions (e.g. photon numbers or photon rates) and scanning positions assigned to the light emissions (positions of the local minimum of the intensity distribution of the illumination light) or shapes and/or orientations of the intensity distribution of the illumination light assigned to the light emissions as input data. The position estimator may be, for example, a maximum likelihood estimator or a least-mean-squares estimator. According to the present disclosure, the position estimator may be adjusted to correct for effects of aberrations of the illumination light on the position estimate of singulated emitters. In particular, the position estimator may also be adjusted in combination with or in addition to the control of a beam shaping device, especially in order to correct residual errors. In MINFLUX position estimators according to the prior art, the intensity distribution of the illumination light is often assumed to be parabolic, for example, which is a good approximation for a certain range around the local minimum. According to the present disclosure, an expression for the shape of the intensity distribution adapted based on the aberration correction function can now be used in the position estimator, for example, in order to take into account the effects of the aberrations on the position estimate.

According to a further embodiment, the scanning step is performed successively on different singulated emitters. In principle, the method according to the present disclosure can also be carried out on one single emitter, in particular if it is an especially photostable emitter that can emit a large number of photons before going into a dark state. However, performing the method on different emitters has the advantage that a much larger amount of data can be collected, even compared to a single photostable emitter, which increases the accuracy with which the value of the at least one parameter or the at least one support point of the aberration correction function is determined. In particular, the light emissions detected at a scanning position may be a sum of light emissions from multiple emitters.

According to a further embodiment, a second estimated position of the singulated emitter is determined with an increased accuracy compared to the first estimated position, wherein, based on the second estimated position, the scanning positions used in the at least one scanning step are shifted by a respective difference vector between the respective first estimated position and the respective second estimated position, and wherein the value of the at least one parameter or the at least one support point of the aberration correction function is determined based on the light emissions detected for the shifted scanning positions.

The second estimated position is regarded as the actual position of the corresponding emitter and the scanning positions, in particular from the scanning steps of a large number of emitters, are normalized to this position. This means that a coordinate transformation is performed in order to analyze the distribution of the light emissions around the actual emitter position. If the light emissions of several emitters are used for aberration correction, all light emissions can be related to the respective actual position in this way. In this way, more light emissions can be analyzed, which increases the accuracy of the aberration correction.

In the embodiment described, the higher position uncertainty of the first estimated position is utilized in order to obtain a large number of scanning positions. This is because the first estimated position is randomly shifted relative to the second estimated position due to the position uncertainty, i.e. the difference vector has randomly different lengths and directions. For different emitters or when the first estimated position of an emitter is determined several times, the randomly shifted scanning pattern results in different (shifted) scanning positions relative to the second estimated position. In this way, even with a scanning pattern with relatively few (e.g. three to six) scanning positions, the point spread function can be sampled at many points. This has the advantage that the values of a large number of parameters or a large number of support points of an aberration correction function (e.g. the parameters of a large number of Zernike polynomials) can be determined.

The scanning positions shifted by the difference vector may, in particular, be assigned to different scanning steps with different scanning patterns, in particular different sized scanning patterns.

Furthermore, between the determination of the first estimated position and the second estimated position, at least one further estimated position of the singulated emitter can be determined from the light emissions of at least one scanning step. In this way, the accuracy of the position determination can be successively increased.

According to a further embodiment, the second estimated position is determined using a MINFLUX method. In this way, the second estimated position can be determined with a very high accuracy (e.g. a deviation of a few nanometers), so that it corresponds very well to the actual position of the corresponding emitter. This improves the accuracy of the determination of the value of the at least one parameter or the at least one support point of the aberration correction function. In addition to its use for aberration correction, the second estimated position can advantageously additionally be used for high-resolution imaging of sample structures in a method for localizing a singulated emitter according to the fourth aspect.

If the second estimated position is determined according to a MINFLUX method, an iterative MINFLUX method can be performed in particular by determining at least one further position of the singulated emitter from the light emissions of at least one scanning step between the determination of the first estimated position and the determination of the second estimated position and placing the scanning pattern of the respective subsequent step as a function of the further estimated position, in particular centering it at the further estimated position.

Alternatively, the second estimated position may also be a previously known position of the corresponding emitter, e.g. when the emitter is coupled to a sample structure with a known position. In this case, the second estimated position does not have to be determined by a localization procedure, but can be retrieved from a data memory, for example. In this case, too, the position is referred to as the “estimated position”, as the previously known position cannot be specified with arbitrarily high accuracy here either.

According to a further embodiment, the scanning positions are arranged around a randomly shifted position based on the first estimated position. In this way, the variability of the sampling can be increased, i.e. more different scanning positions can be generated, for example if the random spread of the first estimated position is less than desired.

According to a further embodiment, the scanning step is carried out with different scanning patterns, in particular scanning patterns of different sizes. For example, three to six scanning positions arranged on a circle around the first estimated position can be used, wherein the diameter of the circle is adjusted. This also results in a larger number of scanning positions in relation to the actual position of the respective emitter, which improves determination of it and thus the determination of the value of the at least one parameter or the at least one support point for the aberration correction function. A similar procedure is used in iterative MINFLUX methods according to the prior art in order to gradually increase the position accuracy. With a suitable size of the scanning pattern, MINFLUX data from different iteration steps could also be used for aberration correction, for example.

According to a further embodiment, the scanning pattern is a continuous path around the first estimated position, in particular wherein a corresponding scanning position is determined when the light emissions are detected. When traveling along the continuous path, the intensity distribution particularly performs a uniform movement, e.g. a uniform circular movement. The scanning positions are then not fixed, but result from the times at which light emissions, e.g. individual photons, were detected. The scanning movement of the intensity distribution then results in a corresponding scanning position for each light emission. The scanning positions at specific points in time can be obtained, for example, from the control signal of a scanner or from a measurement with a position sensor. For the method according to the present disclosure, such a type of scanning has the advantage that, due to the stochastic photon emission, different scanning positions are obtained for each scanning step, even relative to the first estimated position. This increases the variability, i.e. leads to a larger number of scanning positions. This results in an improved determination of the at least one parameter or the at least one support point of the aberration correction function

Different, in particular differently sized, continuous paths around the first estimated position may also be used in different scanning steps. In particular, the scanning pattern (here the continuous path) may be successively shrunk in an iterative process. Therein, the scanning pattern may also be re-centered, e.g. if a further estimated position with higher accuracy than the first estimated position is determined from the light emissions. In this case, the scanning pattern may, for example, be centered on the further estimated position.

According to a further embodiment, the illumination light is excitation light which excites emitters in the sample to luminescence, in particular fluorescence, or which is scattered or reflected by emitters in the sample.

According to a further embodiment, the scanning pattern comprises scanning positions with different coordinates along or parallel to an optical axis of an objective with which the sample is illuminated with the illumination light.

In other words, an axial, in particular three-dimensional, scanning pattern is used. With such a scanning pattern (possibly in combination with a further lateral scanning pattern), it is possible to spatially sample the intensity distribution of the illumination light, in particular in order to obtain an aberration correction for a three-dimensional localization or tracking method in which singulated emitters are localized in all three spatial directions.

According to a further embodiment, the intensity distribution of the illumination light comprises intensity increase areas adjacent to the local minimum in all spatial directions, in particular wherein the intensity distribution is a bottle beam.

A bottle beam (sometimes also referred to as a 3D donut) is an intensity distribution that results from phase modulation of the illumination light (in particular in a pupil plane conjugate to a back aperture of the objective) with an annular phase pattern with a phase jump of π (in particular wherein an outer area and an inner area of the phase pattern have the same area) and focusing of the illumination light into the sample. A bottle beam can be used advantageously for 3D localization or 3D tracking of singulated emitters, as there is also an intensity gradient of the illumination light along the optical axis and thus information about the axial coordinate of the emitter can be obtained. In contrast to a (2D) donut, a bottle beam generates additional intensity at the central minimum, in particular due to spherical aberrations, so that there is no longer an intensity null there. This worsens the position estimation.

According to a further embodiment, the value of the at least one parameter or the at least one support point of the aberration correction function is determined based on light emissions from different emitters, wherein data sets are stored in which the value of the at least one parameter or the at least one support point is assigned to a position in the sample, so that the data sets represent a one-dimensional, two-dimensional or three-dimensional map of parameter values or support points, in particular wherein the positions in the sample form a regular grid with spacings of at least 500 nm, in particular at least 1 μm. In particular, the different emitters have spacings of at least 500 nm, in particular at least 1 μm. The position in the sample to which the parameter values or reference points are assigned may correspond to the position of the respective emitter (e.g. the second estimated position determined with high precision can be used for this) or the position can be derived from the position of the emitter, e.g. by an interpolation method.

For example, the spherical aberration increases with the depth in the sample (i.e. the axial distance to the cover glass). In addition, the aberrations in a sample can also differ greatly from each other locally in a plane perpendicular to the optical axis, e.g. due to an inhomogeneous refractive index distribution. With the embodiment described above, a position-specific aberration correction is advantageously possible under such conditions, e.g. by selecting the corresponding data set depending on the position at which an emitter to be localized is found (in particular at the position that is determined with a pre-localization) and using the corresponding parameter values or support points for the aberration correction function.

According to a further embodiment, the aberration correction function comprises at least one Zernike polynomial.

According to a further embodiment, the scanning pattern comprises a maximum extension of 250 nm or more, in particular 300 nm or more. Therein, the maximum extension can be, for example, the diameter of a circle or a sphere or the main axis of an ellipse or an ellipsoid. A maximum extension in the specified range has the advantage that information about the point spread function of an emitter illuminated with the illumination light can be collected effectively, so that meaningful values can be obtained for determining the value of the at least one parameter or the at least one support point of the aberration correction function. In iterative MINFLUX methods, the scanning pattern is usually significantly smaller than 100 nm, at least in the last iteration, e.g. scanning patterns with a diameter of 40 nm are described in the prior art. If the method for aberration correction according to the present disclosure is therefore carried out in parallel with an iterative MINFLUX method for localizing or tracking singulated emitters, the data for determining the value of the at least one parameter or the at least one support point of the aberration correction function is obtained in particular from “early” to “middle” iteration steps in order to ensure sufficient sampling, while the later iteration steps are used in particular exclusively for localizing the emitter.

According to another embodiment, the intensity distribution of the illumination light in a focal plane of the illumination light perpendicular to an optical axis of an objective with which the sample is illuminated with the illumination light comprises at least two intensity maxima, wherein a maximum extension of the scanning pattern is 75% to 125% of the distance between the intensity maxima in the focal plane. In this way, information about the point spread function of an emitter illuminated with the illumination light can be collected effectively. The distance between the maxima of the intensity distribution depends in particular on the wavelength of the illumination light.

In certain embodiments, singulated emitters in a sample are localized or tracked, wherein respective light emissions of a singulated emitter are detected for different scanning positions of the intensity distribution or different shapes and/or arrangements of the intensity distribution, and wherein a third estimated position of the emitter is determined based on the light emissions and the associated scanning positions or shapes and/or arrangements by means of a position estimator, wherein the intensity distribution of the illumination light and/or the position estimator is adjusted based on the aberration correction function

In certain embodiments, at least a part of the light emissions used to determine the third estimated position are also used to determine the value of the at least one parameter or the at least one support point of the aberration correction function.

In certain embodiments, the method for locating or tracking a singulated emitter comprises at least a first iteration step and a second iteration step, wherein in the second iteration step the third estimated position is determined with a higher accuracy than in the first iteration step, and wherein the second iteration step is carried out based on the third estimated position determined in the first iteration step, and wherein the light emissions detected in the first iteration step are also used to determine the value of the at least one parameter or the at least one support point of the aberration correction function.

In certain embodiments, light emissions of first emitters are used to determine the value of the at least one parameter or the at least one support point of the aberration correction function, wherein light emissions of second emitters are used to determine the third estimated position of the second emitters.

A second aspect of the present disclosure relates to a system for aberration correction of an illumination light for a localization microscope, in particular a MINFLUX microscope, according to a method according to the first aspect, wherein the system comprises a computing unit (or processor) which is configured to determine, based on light emissions detected by means of a detector of the localization microscope during the at least one scanning step, a value of at least one parameter or at least one support point of an aberration correction function, the aberration correction function describing a deviation of a shape of the intensity distribution of the illumination light from a desired shape of the intensity distribution or a deviation of a phase distribution of the illumination light from a desired phase distribution.

According to one embodiment, the system comprises a control unit (or controller) which is configured to control a beam shaping device of the localization microscope in such a way that a shape of the intensity distribution of the illumination light is adapted based on the aberration correction function.

According to a further embodiment, the computing unit or a further computing unit (or processor) of the system is configured to adapt a position estimator for estimating the position of a singulated emitter in a sample, in particular according to a MINFLUX method, based on the aberration correction function.

A third aspect of the present disclosure relates to a non-transitory computer-readable medium for storing computer instructions for aberration correction that, when executed by one or more processors associated with a system according to the second aspect causes the one or more processors to perform the method according to the first aspect.

Further embodiments and advantages of the system according to the second aspect and of the non-transitory computer-readable medium according to the third aspect result analogously from the description of the method according to the first aspect.

A fourth aspect of the present disclosure relates to a method for localizing or tracking singulated emitters in a sample, wherein an illumination light is focused into a sample, wherein an intensity distribution of the illumination light comprising a local minimum is generated at the focus of the illumination light in the sample, and wherein for different scanning positions of the intensity distribution or different shapes and/or arrangements of the intensity distribution respective light emissions of a singulated emitter induced or modulated by the illumination light are detected, and

wherein a third estimated position of the singulated emitter is determined based on the light emissions and the associated scanning positions or shapes and/or arrangements by means of a position estimator, and wherein the intensity distribution of the illumination light and/or the position estimator is adapted based on an aberration correction function, wherein a value of at least one parameter or at least one support point of the aberration correction function is determined by the method for aberration correction according to the first aspect.

A method for localizing singulated emitters is understood to be a method in which positions of singulated emitters are determined, in particular separately, wherein a localization map of sample structures can be created from the positions, which resembles a high-resolution image of the sample, but in particular no optical imaging of the sample onto a detector and no conventional scanning in the sense of a raster scan of the sample (for example with confocal laser scanning microscopy) takes place.

During “tracking”, an emitter that can move in the sample is localized several times in succession in order to obtain a trajectory of the emitter.

The method according to the fourth aspect of the present disclosure is a MINFLUX method as defined in this specification.

The illumination light is in particular excitation light that excites emitters in the sample to luminescence, in particular fluorescence, or is reflected and/or scattered by emitters in the sample. Alternatively, the illumination light may also be, for example, inhibition light (e.g. STED light) or switching light.

In particular, the illumination light is the same illumination light that is used for the aberration correction method according to the first aspect. In particular, the illumination light used in the method according to the first aspect has the same wavelength as the illumination light used in the method according to the fourth aspect. However, a different illumination light may also be used for localization or tracking than for aberration correction.

The emitters that are localized or tracked using the method according to the fourth aspect may be of the same species as the emitters with which the method for aberration correction is performed. However, this is not necessarily the case. For example, it is possible to scan nanoparticles labeled with a plurality of fluorophores for the aberration correction method, while the method according to the fourth aspect can be used to localize biological sample structures labeled on singulated fluorophores, for example. These fluorophores may belong to the same species or to a different species, wherein in the latter case they can be excited in particular with the same illumination light.

In particular, the method for aberration correction according to the first aspect and the method for localizing or tracking emitters according to the fourth aspect may be performed on the same sample. This has the advantage that the data for the aberration correction and for the high-precision structure analysis can be collected at the same location in the sample. In this case, the aberration correction takes into account the spatial refractive index distribution of this sample region of interest particularly well.

Alternatively, a separate sample may be used for the method for aberration correction according to the first aspect, for example a calibration sample. In this case, the value of the at least one parameter or the at least one support point of the aberration correction function can be stored in order to then apply the aberration correction function to a measurement on other samples according to the method according to the fourth aspect.

If the sample and the emitter species coincide in the method according to the first aspect and according to the fourth aspect, at least part of the recorded measurement data may advantageously be used twice—for determining the value of the at least one parameter of the aberration correction function and for localizing sample structures to create a high-resolution localization map. In this case, the third estimated position determined in the method according to the fourth aspect may coincide with the second estimated position determined in the method according to the first aspect.

According to one embodiment, at least a part of the light emissions used to determine the third estimated position are also used to determine the value of the at least one parameter or the at least one support point of the aberration correction function. The measurement data is advantageously used twice, which increases the efficiency of the method. In the case of an iterative method, it is not necessary to use the light emissions from all iteration steps twice.

If a beam shaping device is controlled based on the determined aberration correction function, the aberration correction function can be iteratively improved in the course of performing the method according to the fourth aspect—the aberration correction improved based on previous measurements is applied to subsequent measurement steps and a further improved aberration correction function is obtained in parallel. In the case of adapting a position estimator based on the aberration correction function, all localization data can even be corrected with the final aberration correction function in the course of post-processing the data.

According to a further embodiment, the method for localizing or tracking a singulated emitter comprises at least a first iteration step and a second iteration step, wherein in the second iteration step the third estimated position is determined with a higher accuracy than in the first iteration step, and wherein the second iteration step is performed based on the third estimated position determined in the first iteration step, and wherein the light emissions detected in the first iteration step (in particular only the light emissions detected in the first iteration step, but not the light emissions detected in the second iteration step) are also used to determine the value of the at least one parameter or the at least one support point of the aberration correction function. In particular, in the first iteration step, a scan pattern having a first maximum extent (e.g., a circle having a first diameter) is used and in the second iteration step, a scan pattern having a second maximum extent (e.g., a circle having a second diameter) is used, wherein the second maximum extent is smaller than the first maximum extent. For the method according to the fourth aspect, this has the advantage that a higher positional accuracy is achieved. However, for the aberration correction according to the first aspect, the data from the first iteration with the larger scanning pattern can be used, since the at least one parameter value or the at least one support point of the aberration correction function can be better determined due to the support points in a larger area.

Due to the size of the point spread function of an emitter, it is advantageous to use only the early or middle iteration steps, in which a maximum extension, in particular a diameter, of the scanning pattern corresponds, for example, to at least 250 nm or at least the distance between two maxima adjacent to the local minimum of the intensity distribution, for aberration correction and to use the later iteration steps exclusively for localization or tracking.

According to a further embodiment, light emissions from first emitters are used to determine the value of the at least one parameter or the at least one support point of the aberration correction function, wherein light emissions from second emitters are used to determine the third estimated position of the second emitters. The first emitters may be of a different species than the second emitters. Alternatively, the first emitters and the second emitters may belong to the same species but be located, for example, in different regions of the sample. The use of first and second emitters has the advantage that the first emitters can, in principle, be illuminated during scanning to determine the value of the at least one parameter or the at least one support point of the aberration correction function until they bleach or change to a dark state. Due to the larger number of light emissions, the parameter determination can be carried out more accurately.

If the first emitters and the second emitters belong to different species, the first emitters and the second emitters can be illuminated with illumination light of different wavelengths according to a further embodiment. In particular, the illumination light of the wavelength used in the method for aberration correction has little or no effect on the second emitters (in particular, it does not excite them). This has the advantage that data can first be recorded for aberration correction on the same sample without damaging the second emitters or transferring them to a dark state. Then, for example, a localization experiment can be carried out with a high marking density of the sample using the aberration correction. It is also advantageous if the illumination light of the wavelength used for localization or tracking in the method does not influence (in particular does not excite) the first emitters so that no interference signal occurs for the localization of the second emitters. In particular, the first emitters may have a higher photostability than the second emitters. For example, the first emitters may be nanoparticles labeled with fluorescent markers or reflective/light-scattering nanoparticles, while the second emitters may be, for example, fluorophores that can be coupled to sample structures of interest.

According to a further embodiment, the first emitters are reversibly coupled to structures in the sample, wherein the first emitters are exchanged for the second emitters after detection of the light emissions for determining the value of the at least one parameter or the at least one support point of the aberration correction function. Methods known from the prior art under the name “Exchange-PAINT”, for example, can be used for reversible marking. The first and second emitters may belong to the same species or be different.

In this way, data for aberration correction can be recorded at exactly the same points where the sample structures to be localized are located. The aberration correction function therefore takes the local refractive index distribution of the sample in particular into account extremely accurately. In addition, the parameter values can be determined with a large number of light emissions and therefore very accurately. Therein, it does not matter if the emitters are damaged or go into a dark state, as they are then replaced with new emitters, which can be used to analyze the sample structures of interest using the aberration correction according to the present disclosure.

According to a further embodiment, the first emitters and the second emitters differ in the mechanism of excitation (e.g. fluorescence and scattering/reflection), in their excitation spectrum, their emission spectrum and/or their emission lifetime. This also has the advantage that the emitters used for the localization of the sample structures of interest are not damaged or transferred to a dark state, as the data acquisition for the aberration correction is carried out with other emitters. If necessary, wavelength differences in the excitation and/or emission spectrum can be taken into account by adjusting the aberration correction function accordingly. This is advantageously not necessary when evaluating the emission lifetime, as the aberrations do not depend on the emission lifetime.

According to a further embodiment, depending on a position (e.g. a position roughly estimated in a pre-localization) of the singulated emitter, at least one value of a parameter or at least one support point of the aberration correction function is selected from stored data sets. In this way, a position-dependent aberration correction can be performed (see above)

A fifth aspect of the present disclosure relates to a localization microscope for localizing or tracking singulated emitters in a sample, in particular according to a method according to the fourth aspect. The localization microscope comprises an illumination optical system (or illuminator) which is configured to focus an illumination light, in particular an excitation light, into a sample and to generate an intensity distribution of the illumination light comprising a local minimum at the focus of the illumination light in the sample, a detector which is configured to detect respective light emissions of a singulated emitter induced or modulated by the illumination light for different scanning positions of the intensity distribution or different shapes and/or arrangements of the intensity distribution, and a computing unit which is configured to estimate a third estimated position of the singulated emitter based on the light emissions by means of a position estimator. The localization microscope further comprises a system for aberration correction according to the fourth aspect, wherein the computing unit of the system is configured to determine a value of at least one parameter or at least one support point of an aberration correction function based on light emissions detected by the detector of the localization microscope during the at least one scanning step.

In particular, the localization microscope may be a MINFLUX microscope according to the definition used in this specification.

In particular, the illumination optical system comprises an illumination light source, in particular a laser, and an objective which is configured to focus the illumination light into the sample. In addition, the illumination optical system comprises in particular a light modulator which is configured to spatially modulate the phase and/or the amplitude of the illumination light so that the illumination light focused by the objective into the sample forms the intensity distribution with the local minimum.

According to one embodiment, the localization microscope comprises at least one scanning device (or scanner) that is configured to displace the intensity distribution of the illumination light to scanning positions in the sample. This may, for example, be a fast scanning device based on electro-optical or acousto-optical deflectors. In particular, the beam shaping device may be used for axial displacement of the intensity distribution, particularly if it is configured as a deformable mirror or spatial light modulator. Alternatively, a separate axial scanning device may be used, e.g. a deformable mirror or a varifocal lens. In addition to the fast scanning device, a further lateral scanning device, e.g. a galvanometer scanning device, may be provided, which can be used in particular for coarse positioning of the illumination light and/or for pre-localization (determination of the first estimated position), for example by pinhole orbit scanning or raster scanning.

Alternatively or additionally, the localization microscope may comprise a switching device for changing the shape and/or arrangement of the intensity distribution, e.g. using a biaxial crystal.

According to a further embodiment, the localization microscope comprises a control unit and a beam shaping device coupled to the control unit, in particular a deformable mirror or a spatial light modulator, wherein the control unit is configured to control the beam shaping device in such a way that a shape of the intensity distribution of the illumination light is adapted based on the aberration correction function.

According to a further embodiment, the computing unit or a further computing unit of the localization microscope is configured to adapt the position estimator based on the aberration correction function.

A sixth aspect of the present disclosure relates to a non-transitory computer-readable medium for storing computer instructions for localizing or tracking emitters in a sample that, when executed by one or more processors associated with the localization microscope according to the fifth aspect, causes the one or more processors to perform the method of localizing or tracking emitters in a sample according to the fourth aspect.

Further embodiments of the method according to the fourth aspect result from the above description of the method according to the first aspect. Further embodiments of the localization microscope according to the fifth aspect and of the non-transitory computer-readable medium according to the sixth aspect result from the above description of the method according to the fourth aspect.

A further aspect of the present disclosure relates to a system for aberration correction of an illumination light for a localization microscope, comprising an illumination optical system configured to focus the illumination light into a sample and to generate an intensity distribution of the illumination light with at least one local minimum at the focus of the illumination light in the sample, at least one scanning device configured to scan the sample in at least one scanning step with the intensity distribution at scanning positions which form a scanning pattern around a first estimated position of a singulated emitter in the sample, a detector configured to detect light emissions of the singulated emitter for each of the scanning positions, and a computing unit configured to determine a value of at least one parameter or at least one support point of an aberration correction function based on the light emissions detected during the at least one scanning step, wherein the aberration correction function describes a deviation of a shape of the intensity distribution of the illumination light from a desired shape of the intensity distribution or a deviation of a phase distribution of the illumination light from a desired phase distribution.

In certain embodiments, the system comprises a beam shaping device configured to shape the intensity distribution of the illumination light, and a control unit which is configured to control the beam shaping device in such a way that the shape of the intensity distribution of the illumination light is adapted based on the aberration correction function.

In certain embodiments, the computing unit is configured to adapt a position estimator for estimating the position of a singulated emitter in a sample based on the aberration correction function.

Further embodiments and advantages of the system can be found in the specification relating to the first to sixth aspect.

Yet a further aspect of the present disclosure relates to a localization microscope for localizing or tracking singulated emitters in a sample, comprising an illumination optical system which is configured to focus an illumination light into a sample and to generate an intensity distribution of the illumination light comprising a local minimum at the focus of the illumination light in the sample, at least one scanning device configured to scan the sample in at least one scanning step with the intensity distribution at scanning positions which form a scanning pattern around a first estimated position of a singulated emitter in the sample, a detector which is configured to detect respective light emissions of a singulated emitter for different scanning positions of the intensity distribution or different shapes and/or arrangements of the intensity distribution, and a computing unit which is configured to estimate a third estimated position of the singulated emitter based on the light emissions detected for the different scanning positions or for the different shapes and/or arrangements of the intensity distribution by means of a position estimator, wherein the computing unit or a further computing unit of the localization microscope is configured to determine a value of at least one parameter or at least one support point of an aberration correction function based on the light emissions detected during the at least one scanning step, wherein the aberration correction function describes a deviation of a shape of the intensity distribution of the illumination light from a desired shape of the intensity distribution or a deviation of a phase distribution of the illumination light from a desired phase distribution.

In certain embodiments, the localization microscope comprises a beam shaping device configured to shape the intensity distribution of the illumination light, and a control unit which is configured to control the beam shaping device in such a way that the shape of the intensity distribution of the illumination light is adapted based on the aberration correction function.

In certain embodiments, the computing unit or the further computing unit of the localization microscope is configured to adapt the position estimator based on the aberration correction function.

Further embodiments and advantages of the localization microscope can be found in the specification relating to the first to sixth aspect.

Advantageous further embodiments of the present disclosure are shown in the claims, the description and the drawings and the associated explanations of the drawings. The described advantages of features and/or combinations of features of the present disclosure are merely exemplary and can be used alternatively or cumulatively.

With regard to the disclosure (but not the scope of protection) of the original application documents and the patent, the following applies: Further features can be found in the drawings—in particular the relative arrangements and active compounds shown. The combination of features of different embodiments of the present disclosure or of features of different claims is also possible in deviation from the selected relationships of the claims and is hereby encouraged. This also applies to those features which are shown in separate drawings or are mentioned in their description. These features can also be combined with features of different claims. Likewise, features listed in the claims can be omitted for further embodiments of the present disclosure, but this does not apply to the independent claims of the granted patent.

In the following, embodiments of the present disclosure are described with reference to figures. These do not limit the subject matter of this disclosure and the scope of protection.

### BRIEF DESCRIPTION OF THE FIGURES

FIG. 1 shows a schematic representation of an embodiment of a scanning pattern according to the present disclosure;

FIG. 2 shows a schematic representation of an embodiment of the method for aberration correction according to the present disclosure;

FIG. 3 shows an embodiment of the localization microscope according to the present disclosure with a system for aberration correction according to the present disclosure.

### DESCRIPTION OF THE FIGURES

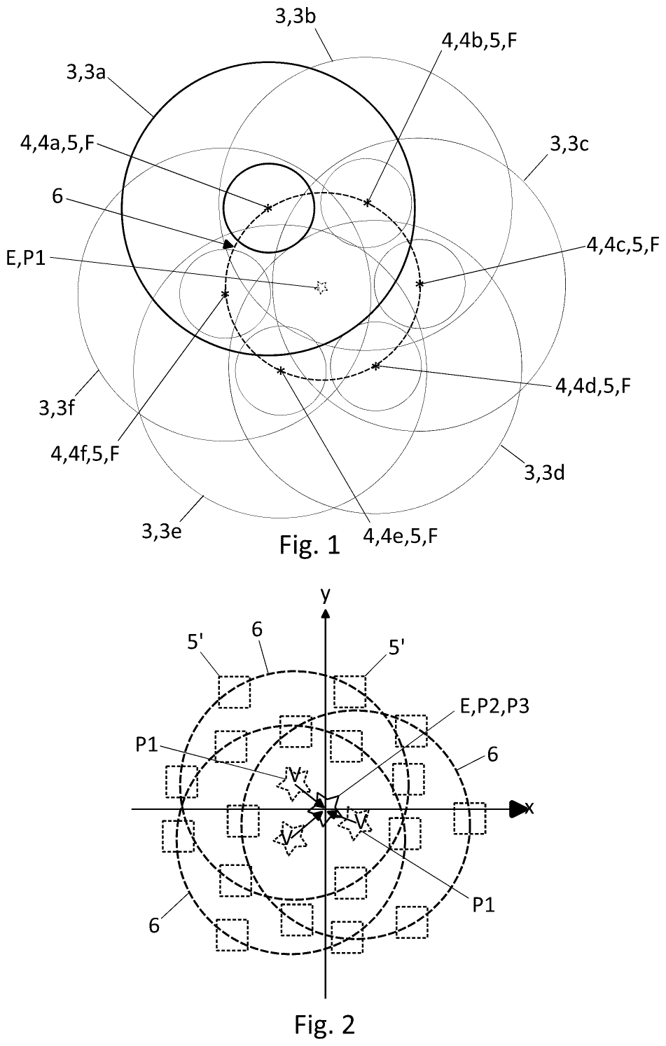

FIG. 1 schematically shows a scanning pattern 6 consisting of scanning positions 5 at which a sample 2 is scanned in a focal plane with an intensity distribution 3 of an illumination light B.

The intensity distribution 3 is shown schematically as a section in the focal plane and comprises a central minimum 4 (ideally an intensity zero) and a ring-shaped maximum (not shown) at a geometric focus F of the illumination light beam. The intensity distribution 3 may, for example, be a so-called donut or a so-called bottle beam. These intensity distributions are known from the prior art of STED and MINFLUX microscopy.

According to the example embodiment, the minimum 4 of the intensity distribution 3 is arranged successively at six scanning positions 5 positioned symmetrically on a circle, which form a scanning pattern 6 around a first estimated position P1 of a singulated emitter E.

The first estimated position P1, whose accuracy may be much lower than the accuracy of the final position of the emitter E to be determined, may be determined in advance using an independent method such as confocal scanning of the sample 2 with a regular Gaussian focus, wide-field microscopy or pinhole orbit scanning. This can be done, for example, as part of a so-called pre-localization.

In particular, in a MINFLUX method for localizing a single emitter E, light emissions L of the emitter E may be detected for each scanning position 5, wherein the position of the emitter E can be estimated with a position estimator using the known coordinates of the scanning positions 5 and the respective light emissions L detected at these positions (e.g. photon numbers).

Such a method can be carried out iteratively, wherein in an iteration step the scanning pattern 6 is arranged around a position determined in the previous iteration. The scanning pattern 6 may be successively reduced in size in order to increase the positional accuracy, i.e. the diameter of the circle on which the scanning positions 5 are located can be reduced, for example, wherein the light intensity of the illumination light B may also be increased in particular.

In particular, misalignments in the illumination beam path and differences between the refractive index of the sample and the immersion medium can cause aberrations of the illumination light B, which can lead, for example, to a non-zero intensity at the local minimum 4 of the intensity distribution 3 and/or to a distortion of the intensity distribution 3.

To correct aberrations, a beam shaping device 7, such as a deformable mirror 8 or a spatial light modulator 9, can be controlled using an aberration correction function, e.g. using Zernike polynomials, to shape the wavefront in such a way that an aberration-corrected intensity distribution 3 is obtained.

Parameter values or support points of an aberration correction function (such as the coefficients of the Zernike polynomials) can be determined in different ways according to the prior art. For example, the wavefront of the illumination light could be measured directly using a Shack-Hartmann sensor. However, this solution would require additional components and additional installation space and has the disadvantage that it is difficult to determine the effects of the refractive index in the sample.

An alternative known from classical light microscopy is sensorless aberration correction based on an image metric (e.g. based on image brightness, resolution and/or sharpness). However, since localization microscopy based on the MINFLUX principle does not involve true image acquisition, but rather the localization of singulated emitters, there is no generally applicable measure of image quality.

Therefore, according to the present disclosure, the value of at least one parameter or at least one support point of an aberration correction function for the illumination light B (which may be modified by aberrations) is determined by scanning the sample 2 with the intensity distribution 3 with the local minimum 4 and detecting light emissions.

Such a determination is similar to the confocal scanning of a point emitter with a regular focus, with the difference that the point spread function is not a Gaussian distribution here, but reflects the intensity distribution of the illumination light B and therefore comprises a central local minimum.

Accordingly, parameter values or support points of an aberration correction function, which describes a deviation of the shape of the intensity distribution 3 from a desired intensity distribution (in particular a symmetrical distribution with a central zero) or a deviation of a phase distribution of the illumination light B from a desired phase distribution, can be determined, for example, by a function fit to the light emissions obtained for the different scanning positions 5.

For example, the light intensities L measured for the different scanning positions 5 in the method according to the present disclosure can be fitted to the desired intensity distribution 3 of the illumination light B in the sample 2. This function fit may, for example, be carried out successively with intensity distributions 3 that contain different aberration terms, wherein the coefficients of the aberration terms are adjusted until a deviation between the measured light emissions and the respective function is minimized. The intensity distribution 3 with the smallest deviation can then be selected. The parameter values of the aberration correction function can be determined based on this intensity distribution 3.

Subsequently, for example, the beam shaping device 7 may be controlled based on the aberration correction function in order to adjust the wavefront of the illumination light and compensate for the aberrations. Instead of or in addition to this, the position estimator for a MINFLUX method may be adjusted based on the aberration correction function in order to correct localization errors caused by the aberrations.

In particular, the scanning pattern 6 has a suitable size for determining the parameter values or support points of the aberration correction function, so that the scanning positions cover the point spread function of the emitter well enough to be able to determine parameter values or support points. In particular, the scanning pattern 6 may have a diameter that corresponds approximately to the distance between the opposing maxima of the intensity distribution 3, in this case the diameter of the ring-shaped maximum. This diameter may, for example, be in the range between 250 nm and 450 nm, in particular between 300 nm and 400 nm.

In principle, if the emitter position is known, it is possible to determine the intensity distribution 3 of the illumination light B by evaluating the total light emissions detected at the six scanning positions 5 shown in FIG. 1 (from one emitter or several emitters) if the scanning pattern 6 is of sufficient size so that enough positions are scanned. The known emitter position may be determined, for example, by an independent method or by a highly accurate MINFLUX localization.

However, with the method described above, the six scanning positions 5 of the scanning pattern 6 shown in FIG. 1 would not be sufficient to determine more complex aberration correction functions. For example, when using Zernike polynomials to correct various aberrations, it may be necessary to determine far more than six independent parameters, for which a system of equations with six scanning positions would be underdetermined.

As shown schematically in FIG. 2, according to one embodiment of the method according to the present disclosure, the position uncertainty of the determination of the first estimated position (pre-localization) can be exploited in order to obtain light emissions at a plurality of shifted scanning positions 5′ from the scanning of several emitters E with the illumination light B, with which the parameter values of even complex aberration correction functions can be determined.

FIG. 2 schematically illustrates the scanning of three different emitters E with the intensity distribution of the illumination light B. The coordinate system was normalized or transformed to the highly accurately determined second estimated position P2, which approximates the actual emitter position, by shifting the scanning positions 5 assigned to the respective emitter E by means of a difference vector V between the respective first estimated position P1 and the respective second estimated position P2 in order to obtain shifted scanning positions 5′. For all three emitters E, the second estimated position P2 is therefore at the coordinate origin in this representation.

However, the first estimated positions P1, estimated with less accuracy in the pre-localization, deviate randomly from the second estimated position P2 due to their positional uncertainty.

The scanning pattern 6 was centered on the first estimated positions P1 when scanning with the intensity distribution 3, i.e. the first estimated position P1 is the center of the circle on which the scanning positions 5 lie.

Therefore, relative to the second estimated position P2 (here the coordinate origin), eighteen different shifted scanning positions 5′ are obtained, at which the minimum of the intensity distribution relative to the respective scanned emitter E has been located. With a sufficient number of detected photons for each shifted scanning position 5′, this results in 18 independent measured values with which the parameter values or support points of the aberration correction function can be determined.

The second estimated position P2 may be identical to a third estimated position P3, which was determined using a MINFLUX method and can be used, for example, for high-resolution visualization of sample structures.

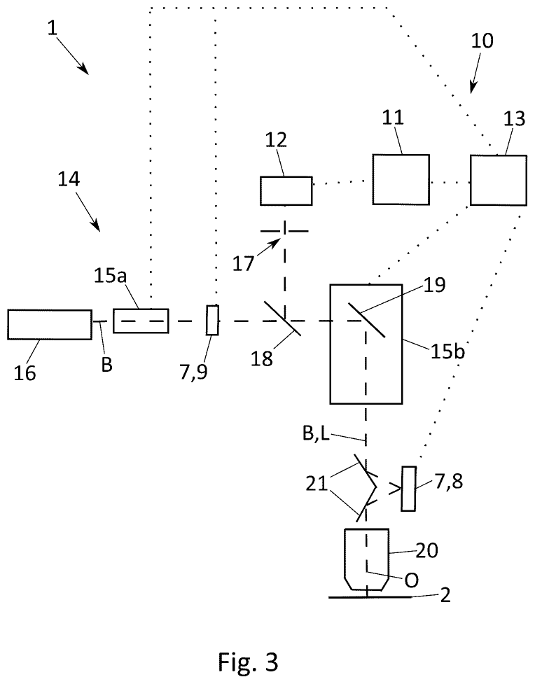

FIG. 3 shows an example embodiment of a localization microscope 1 according to the present disclosure, namely a MINFLUX microscope, comprising a system 10 according to the present disclosure (comprising a computing unit 11, a control unit 13 and a beam shaping device 7) for aberration correction.

The localization microscope 1 comprises a light source 16, in particular a laser, for generating the illumination light B, which is in particular excitation light that excites emitters E in the sample 2 to luminescence, in particular fluorescence, or is reflected or scattered by emitters E in the sample 2.

The illumination light B passes through a first scanning device 15a, e.g. comprising at least one electro-optical or acousto-optical deflector, wherein the first scanning device 15a is configured to displace the focus F of the illumination light B focused by the objective 20 laterally in the sample 2, i.e. perpendicular to an optical axis O of the objective 20.

A spatial light modulator 9 is arranged in the beam path behind the first scanning device 15a, which can be used, for example, to phase-modulate the illumination light B with a phase pattern such that the illumination light B focused by the objective 20 forms an intensity distribution 3 with a local minimum 4 (e.g. a donut or a bottle beam) at the focus F in the sample 2. For this purpose, the illumination light B may be modulated, for example, with a vortex phase pattern (generation of a donut) or a ring-shaped phase pattern (generation of a bottle beam).

In addition, the spatial light modulator 9 alone or in combination with the deformable mirror 8 may also be used as a beam shaping device 7 to correct certain aberrations controlled by the control unit 13 according to the present disclosure, i.e. to shape the wavefront of the illumination light B in such a way that these aberrations are corrected.

The possibly deflected and modulated illumination light B passes through a beam splitter 18 and then passes through a second scanning device 15b, e.g. a galvanometric scanning device. For reasons of clarity, only one controllable scanning mirror 19 of the second scanning device 15b is shown, although the second scanning device 15b comprises in particular at least two such scanning mirrors 19, which particularly deflect the illumination light B laterally in two orthogonal directions.

In particular, the second scanning device 15b may be used for slower coarse positioning of the illumination light B in the sample 2, while the first scanning device 15a is used for fast displacement of the illumination light B to the scanning positions 5 during scanning of the sample 2. Furthermore, the second scanning device 15b, in particular in combination with the first scanning device 15a, may also be used to displace the illumination light B during pre-localization, for example by pinhole orbit scanning.

A deformable mirror 8 is arranged in the beam path between the second scanning device 15b and the objective 20. The illumination light B is projected onto the deformable mirror 8 by a deflecting mirror 21 and the light reflected by the deformable mirror 8 is then directed to the objective 20 by a further deflecting mirror 21.

On the one hand, the deformable mirror 8 may be used as a beam shaping device 7 according to the present disclosure, in that the control unit 13 controls the deformable mirror 8 so that it corrects the aberrations of the illumination light B with the aberration correction function.

On the other hand, the deformable mirror 8 may also be used to focus the intensity distribution 3 in the sample 2, i.e. to axially shift the focus along the optical axis O of the objective 20, e.g. to implement a three-dimensional MINFLUX localization method.

The objective 20 focuses the illumination light B into the sample 2 so that the intensity distribution 3 with the local minimum 4 is formed in the sample 2.

The light emissions L emitted by emitters E in the sample 2 are focused by the objective 20 and pass via the deformable mirror 8 and the second scanning device 15b to the beam splitter 18, in particular a dichroic beam splitter, which reflects the emission light into a detection beam path. In the detection beam path there is an optional pinhole 17 (possibly with additional lens optics for focusing on the pinhole 17, not shown here) and a detector 12, e.g. an avalanche photodiode or a hybrid detector or an array of individual detectors, for detecting the light emissions L.

The detector 12 is connected to a computing unit 11 which is configured to estimate the position of an emitter E in the sample 2 based on the light emissions L detected for different scanning positions 5 using a position estimator, e.g. a maximum likelihood estimator or a least-mean-square estimator.

The detector 12 is further connected to a control unit 13 (directly or, as shown in FIG. 3, via the computing unit 11), which controls the first scanning device 15a, the second scanning device 15b, the deformable mirror 8 and the spatial light modulator 9.

When carrying out the method according to the present disclosure, the computing unit 11 determines parameter values or support points of an aberration correction function (see FIG. 2 and associated description) and controls the deformable mirror 8, the spatial light modulator 9 or both in combination based on the determined parameter values or support points in order to adapt the wavefront of the illumination light B so that the aberrations are corrected for the subsequent recording of localization data.

In addition, the computing unit 11 may be used to adjust the position estimator based on the aberration correction function.

### LIST OF REFERENCE SYMBOLS

1 Localization microscope
2 Sample
3,3a-3f Intensity distribution
4,4a-4f Minimum
5 Scanning position
5′ Shifted scanning position
6 Scanning pattern
7 Beam shaping device
8 Deformable mirror
9 Spatial light modulator
10 System for aberration correction
11 Computing unit
12 Detector
13 Control unit
14 Illumination optical system
15a First scanning device
15b Second scanning device
16 Light source
17 Pinhole
18 Beam splitter
19 Scan mirror
20 Objective
21 Deflecting mirror
B Illumination light
E Emitter
L Light emissions
O Optical axis
P1 First estimated position
P2 Second estimated position
P3 Third estimated position
V Difference vector

1. A method for aberration correction of an illumination light for a localization microscope, wherein the illumination light is focused into a sample, wherein an intensity distribution of the illumination light with at least one local minimum is generated at the focus of the illumination light in the sample, and wherein the sample is scanned in at least one scanning step with the intensity distribution at scanning positions which form a scanning pattern around a first estimated position of a singulated emitter in the sample, and wherein light emissions of the singulated emitter are detected for each of the scanning positions,
wherein a value of at least one parameter or at least one support point of an aberration correction function is determined based on the light emissions detected for the different scanning positions, wherein the aberration correction function describes a deviation of a shape of the intensity distribution of the illumination light from a desired shape of the intensity distribution or a deviation of a phase distribution of the illumination light from a desired phase distribution.

2. The method according to claim 1, wherein the value of the at least one parameter or the at least one support point of the aberration correction function is determined by a function fit of the light emissions detected for the different scanning positions to the desired intensity distribution of the illumination light in the sample.

3. The method according to claim 1, wherein the value of the at least one parameter or the at least one support point of the aberration correction function is determined by means of a trained data processing network.

4. The method according to claim 1, wherein a beam shaping device is controlled in such a way that a shape of the intensity distribution of the illumination light is adapted based on the aberration correction function.

5. The method according to claim 1, wherein a position estimator for estimating a position of a singulated emitter in a sample is adapted based on the aberration correction function.

6. The method according to claim 1, wherein the scanning step is carried out successively for different singulated emitters, wherein the value of the at least one parameter or the at least one support point of the aberration correction function is determined based on the light emissions of the different singulated emitters.

7. The method according to claim 1, wherein a second estimated position of the singulated emitter is determined with an increased accuracy compared to the first estimated position, wherein, based on the second estimated position, the scanning positions used in the at least one scanning step are shifted by a respective difference vector between the respective first estimated position and the respective second estimated position, and wherein the value of the at least one parameter or the at least one support point of the aberration correction function is determined based on the light emissions detected for the shifted scanning positions.

8. The method according to claim 1, wherein the scanning positions are arranged around a randomly shifted position starting from the first estimated position.

9. The method according to claim 1, wherein the illumination light is excitation light which excites emitters in the sample to luminescence, or which is scattered or reflected by emitters in the sample.

10. The method according to claim 1, wherein the value of the at least one parameter or the at least one support point of the aberration correction function is determined based on light emissions from different emitters, wherein data sets are stored, in which the value of the at least one parameter or the at least one support point is assigned to a position in the sample, so that the data sets represent a one-dimensional, two-dimensional or three-dimensional map of parameter values or support points.

11. The method according to claim 1, wherein the intensity distribution of the illumination light in a focal plane of the illumination light perpendicular to an optical axis of an objective, with which the sample is illuminated with the illumination light, comprises at least two intensity maxima, wherein a maximum extension of the scanning pattern is 75% to 125% of the distance between the intensity maxima in the focal plane.

12. The method according to claim 1, wherein singulated emitters in a sample are localized or tracked, wherein respective light emissions of a singulated emitter are detected for different scanning positions of the intensity distribution or different shapes and/or arrangements of the intensity distribution, and wherein a third estimated position of the emitter is determined based on the light emissions and the associated scanning positions or shapes and/or arrangements by means of a position estimator, wherein the intensity distribution of the illumination light and/or the position estimator is adjusted based on the aberration correction function.

13. The method according to claim 12, wherein at least a part of the light emissions used to determine the third estimated position are also used to determine the value of the at least one parameter or the at least one support point of the aberration correction function.

14. The method according to claim 12, wherein the method for locating or tracking a singulated emitter comprises at least a first iteration step and a second iteration step, wherein in the second iteration step the third estimated position is determined with a higher accuracy than in the first iteration step, and wherein the second iteration step is carried out based on the third estimated position determined in the first iteration step, and wherein the light emissions detected in the first iteration step are also used to determine the value of the at least one parameter or the at least one support point of the aberration correction function.

15. The method according to claim 12, wherein light emissions of first emitters are used to determine the value of the at least one parameter or the at least one support point of the aberration correction function, wherein light emissions of second emitters are used to determine the third estimated position of the second emitters.

16. A system for aberration correction of an illumination light for a localization microscope, comprising:
an illumination optical system configured to focus the illumination light into a sample and to generate an intensity distribution of the illumination light with at least one local minimum at the focus of the illumination light in the sample;
at least one scanning device configured to scan the sample in at least one scanning step with the intensity distribution at scanning positions which form a scanning pattern around a first estimated position of a singulated emitter in the sample;
a detector configured to detect light emissions of the singulated emitter for each of the scanning positions; and
a computing unit configured to determine a value of at least one parameter or at least one support point of an aberration correction function based on the light emissions detected during the at least one scanning step, wherein the aberration correction function describes a deviation of a shape of the intensity distribution of the illumination light from a desired shape of the intensity distribution or a deviation of a phase distribution of the illumination light from a desired phase distribution.

17. The system according to claim 16, wherein the system comprises a beam shaping device configured to shape the intensity distribution of the illumination light, and a control unit which is configured to control the beam shaping device in such a way that the shape of the intensity distribution of the illumination light is adapted based on the aberration correction function.

18. The system according to claim 16, wherein the computing unit is configured to adapt a position estimator for estimating the position of a singulated emitter in a sample based on the aberration correction function.

19. A localization microscope for localizing or tracking singulated emitters in a sample, comprising
an illumination optical system which is configured to focus an illumination light into a sample and to generate an intensity distribution of the illumination light comprising a local minimum at the focus of the illumination light in the sample,
at least one scanning device configured to scan the sample in at least one scanning step with the intensity distribution at scanning positions which form a scanning pattern around a first estimated position of a singulated emitter in the sample,
a detector which is configured to detect respective light emissions of a singulated emitter for different scanning positions of the intensity distribution or different shapes and/or arrangements of the intensity distribution, and
a computing unit which is configured to estimate a third estimated position of the singulated emitter based on the light emissions detected for the different scanning positions or for the different shapes and/or arrangements of the intensity distribution by means of a position estimator,
wherein the computing unit or a further computing unit of the localization microscope is configured to determine a value of at least one parameter or at least one support point of an aberration correction function based on the light emissions detected during the at least one scanning step, wherein the aberration correction function describes a deviation of a shape of the intensity distribution of the illumination light from a desired shape of the intensity distribution or a deviation of a phase distribution of the illumination light from a desired phase distribution.

20. The localization microscope according to claim 19, wherein the localization microscope comprises a beam shaping device configured to shape the intensity distribution of the illumination light, and a control unit which is configured to control the beam shaping device in such a way that the shape of the intensity distribution of the illumination light is adapted based on the aberration correction function.

21. The localization microscope according to claim 19, wherein the computing unit or the further computing unit of the localization microscope is configured to adapt the position estimator based on the aberration correction function.
